(19) United States
(12) Patent Application Publication
(10) Pub. No.: US 2026/0024937 A1
(43) Pub. Date: Jan. 22, 2026

(54) MULTI-PIN HOUSING COUPLE FOR AP PP15-45 CONNECTOR

(71) Applicant: VERTIV CORPORATION, Westerville, OH (US)

(72) Inventors: Ozren Milazzi, Zagreb (HR); Tomislav Matovina, Zagreb (HR)

(21) Appl. No.: 19/233,716

(22) Filed: Jun. 10, 2025

Related U.S. Application Data
(60) Provisional application No. 63/673,067, filed on Jul. 18, 2024.

(51) Int. Cl. H01R 13/28; H01R 13/436; H01R 13/512; H01R 107/00

(52) U.S. Cl. CPC H01R 13/28; H01R 13/4361; H01R 13/512; H01R 2107/00

(57) ABSTRACT

An electrical connector assembly is disclosed. The electrical connector assembly may include a first connector assembly and/or a second connector assembly. The first connector assembly may include a first set of hermaphrodite 1P connectors configured to be removably couplable to a second set of hermaphrodite 1P connectors of the second connector assembly. The first connector assembly may include a first set of coiled spring pins configured to be mounted to the first housing, to lock in place the first set of hermaphrodite 1P connectors relative to the first housing, and aligned lengthwise along a vertical axis orthogonal to the coupling axis. The first set of coiled spring pins may include an upper subset configured to be received by upper voids. The first set of coiled spring pins may include a lower subset configured to be received by lower voids.

### CROSS-REFERENCE TO RELATED APPLICATIONS

The present application claims the benefit under 35 U.S.C. § 119 (e) of U.S. Provisional Patent Application Ser. No. 63/673,067 filed Jul. 18, 2024, which is incorporated herein by reference in its entirety.

### TECHNICAL FIELD

The present disclosure generally relates to the field of power distribution, and, more particularly, to electric connectors used in power distribution systems.

### BACKGROUND

In power distribution systems, particularly in data centers, managing connectivity and the effective distribution of power with high reliability and efficiency is crucial. Traditional electrical connectors and their assemblies often pose limitations in terms of durability, ease of connectivity, and adaptability to various configurations.

### SUMMARY

An electrical connector assembly is disclosed in accordance with one or more illustrative embodiments of the present disclosure. In one illustrative embodiment, the electrical connector assembly may include a first connector assembly. In another illustrative embodiment, the first connector assembly may include a first housing configured to be removably couplable along a coupling axis to a second housing of a second connector assembly. In another illustrative embodiment, the first connector assembly may include a first set of hermaphrodite 1P connectors retained by the first housing and configured to be removably couplable to a second set of hermaphrodite 1P connectors of the second connector assembly. In another illustrative embodiment, the first connector assembly may include a first set of coiled spring pins configured to be mounted to the first housing, to lock in place the first set of hermaphrodite 1P connectors relative to the first housing, and aligned lengthwise along a vertical axis orthogonal to the coupling axis. In another illustrative embodiment, the first set of coiled spring pins may include an upper subset configured to be received by upper voids defined by an upper side of the first housing and a lower subset configured to be received by lower voids defined by a lower side of the first housing.

In a further aspect, the first connector assembly may include 15 connector positions arranged in three rows stacked along the vertical axis and in five columns along a lateral axis orthogonal to the vertical axis and the coupling axis. In another illustrative embodiment, at least 13 of the 15 connector positions may include hermaphrodite 1P connectors. In another illustrative embodiment, a length of each of the first set of coiled spring pins may be less than an entirety of a depth of the three rows as measured along the vertical axis. In another illustrative embodiment, a length of each of the first set of coiled spring pins may be at most halfway of a depth of the three rows as measured along the vertical axis.

In another illustrative embodiment, the first housing may include at least four first mounting interfaces configured to be removably couplable to at least four second mounting interfaces of the second connector assembly. In another illustrative embodiment, the first connector assembly may be configured to be removably couplable to the second connector assembly in only one orientation by virtue of a lateral spacing between two mounting interfaces of the at least four first mounting interfaces being different than a different lateral spacing between two other mounting interfaces of the at least four first mounting interfaces. In another illustrative embodiment, the at least four first mounting interfaces may include internal threads for receiving a threaded fastener.

In another illustrative embodiment, the upper subset of the first set of coiled spring pins may consist of a quantity of four upper first set of coiled spring pins. In another illustrative embodiment, the lower subset of the first set of coiled spring pins may consist of a quantity of four lower first set of coiled spring pins.

An electrical connector assembly is disclosed in accordance with one or more illustrative embodiments of the present disclosure. In one illustrative embodiment, the electrical connector assembly may include a second connector assembly. In another illustrative embodiment, the second connector assembly may include a second housing configured to be removably couplable along a coupling axis to a first housing of a first connector assembly. In another illustrative embodiment, the second connector assembly may include a second set of hermaphrodite 1P connectors retained by the second housing and configured to be removably couplable to a first set of hermaphrodite 1P connectors of the first connector assembly. In another illustrative embodiment, the second connector assembly may include a second set of coiled spring pins configured to be mounted to the second housing, to lock in place the second set of hermaphrodite 1P connectors relative to the second housing, and aligned lengthwise along a vertical axis orthogonal to the coupling axis. In another illustrative embodiment, the second set of coiled spring pins may include an upper subset configured to be received by upper voids defined by an upper side of the second housing and a lower subset configured to be received by lower voids defined by a lower side of the second housing.

In a further aspect, the second connector assembly may include 15 hermaphrodite 1P connectors arranged in three rows stacked along the vertical axis and in five columns along a lateral axis orthogonal to the vertical axis and the coupling axis. In another aspect, a length of each of the second set of coiled spring pins may be less than an entirety of a depth of the three rows as measured along the vertical axis. In another aspect, a length of each of the second set of coiled spring pins may be at most halfway of a depth of the three rows as measured along the vertical axis. In another aspect, the second housing may include at least four second mounting interfaces configured to be removably couplable to at least four first mounting interfaces of the first connector assembly. In another aspect, the second connector assembly may be configured to be removably couplable to the first connector assembly in only one orientation by virtue of a lateral spacing between two mounting interfaces of the at least four second mounting interfaces being different than a different lateral spacing between two other mounting interfaces of the at least four second mounting interfaces.

In another aspect, each second mounting interface of the at least four second mounting interfaces may include a threaded fastener configured to couple to a first mounting interface of the first connector assembly. In another aspect, the upper subset of the second set of coiled spring pins may consist of a quantity of four upper second set of coiled spring pins, and the lower subset of the second set of coiled spring pins may consist of a quantity of four lower second set of coiled spring pins. In another aspect, the second housing may include a second gapped portion adjacent to a void defined by the second housing, where the void may be configured to receive a cable tie for securing the second housing to the first housing.

An electrical connector assembly is disclosed in accordance with one or more illustrative embodiments of the present disclosure. In one illustrative embodiment, the electrical connector assembly includes a first connector assembly and a second connector assembly. In another illustrative embodiment, the first connector assembly includes a first housing configured to be removably couplable along a coupling axis to a second housing of the second connector assembly. In another illustrative embodiment, the first connector assembly includes a first set of hermaphrodite 1P connectors retained by the first housing and configured to be removably couplable to a second set of hermaphrodite 1P connectors of the second connector assembly. In another illustrative embodiment, the first connector assembly includes a first set of coiled spring pins configured to be mounted to the first housing, to lock in place the first set of hermaphrodite 1P connectors relative to the first housing, and aligned lengthwise along a vertical axis orthogonal to the coupling axis. In another illustrative embodiment, the first set of coiled spring pins includes an upper subset configured to be received by upper voids defined by an upper side of the first housing and a lower subset configured to be received by lower voids defined by a lower side of the first housing. In another illustrative embodiment, the second connector assembly includes the second housing configured to be removably couplable along the coupling axis to the first housing of the first connector assembly. In another illustrative embodiment, the second connector assembly includes the second set of hermaphrodite 1P connectors retained by the second housing and configured to be removably couplable to the first set of hermaphrodite 1P connectors of the first connector assembly. In another illustrative embodiment, the second connector assembly includes a second set of coiled spring pins configured to be mounted to the second housing, to lock in place the second set of hermaphrodite 1P connectors relative to the second housing, and aligned lengthwise along the vertical axis orthogonal to the coupling axis. In another illustrative embodiment, the second set of coiled spring pins includes an upper subset configured to be received by upper voids defined by an upper side of the second housing and a lower subset configured to be received by lower voids defined by a lower side of the second housing. In another illustrative embodiment, the first connector assembly includes 15 connector positions arranged in three rows stacked along the vertical axis and in five columns along a lateral axis orthogonal to the vertical axis and the coupling axis, where at least 13 of the 15 connector positions include hermaphrodite 1P connectors. In another illustrative embodiment, a length of each of the first set of coiled spring pins is less than an entirety of a depth of the three rows as measured along the vertical axis. In another illustrative embodiment, a length of each of the first set of coiled spring pins is at most halfway of a depth of the three rows as measured along the vertical axis. In another illustrative embodiment, the first housing includes at least four first mounting interfaces configured to be removably couplable to at least four second mounting interfaces of the second connector assembly. In another illustrative embodiment, the first connector assembly is configured to be removably couplable to the second connector assembly in only one orientation by virtue of a lateral spacing between two mounting interfaces of the at least four first mounting interfaces being different than a different lateral spacing between two other mounting interfaces of the at least four first mounting interfaces.

It is to be understood that both the foregoing general description and the following detailed description are exemplary and explanatory only and are not necessarily restrictive of the invention as claimed. Also, it is to be understood that the phraseology and terminology used herein is for the purpose of description and should not be regarded as limiting. The accompanying drawings, which are incorporated in and constitute a part of the specification, illustrate embodiments of the invention, and, together with the general description, serve to explain the principles of the invention.

### BRIEF DESCRIPTION OF THE DRAWINGS

The numerous advantages of the disclosure may be better understood by those skilled in the art by reference to the accompanying figures.

FIG. 1 is an electrical connector assembly in an assembled configuration, in accordance with one or more embodiments of the present disclosure.

FIG. 2A is a perspective view of a first connector assembly of the electrical connector assembly, in accordance with one or more embodiments of the present disclosure.

FIG. 2B is a front view of the first connector assembly, in accordance with one or more embodiments of the present disclosure.

FIG. 3A is a perspective view of a second connector assembly of the electrical connector assembly, in accordance with one or more embodiments of the present disclosure.

FIG. 3B is a front view of the second connector assembly, in accordance with one or more embodiments of the present disclosure.

FIG. 4 is an exploded view of the first connector assembly, in accordance with one or more embodiments of the present disclosure.

FIG. 5 is an exploded view of the second connector assembly, in accordance with one or more embodiments of the present disclosure.

FIG. 6 is a cross-sectional view of the electrical connector assembly, in accordance with one or more embodiments of the present disclosure.

FIG. 7 is a simplified diagram of a hermaphrodite 1P connector configured to be coupled to another hermaphrodite 1P connector of the same design when rotated 180 degrees, in accordance with one or more embodiments of the present disclosure.

FIG. 8 is an electrical connector assembly in an assembled configuration and including an alternate coupling mechanism, in accordance with one or more embodiments of the present disclosure.

### DETAILED DESCRIPTION

Reference will now be made in detail to the subject matter disclosed, which is illustrated in the accompanying drawings.

Embodiments of the present disclosure are directed to electrical connectors that couple to each other and include at least 15 connector positions in a five-by-three arrangement with a dual set of opposing pins for retaining connectors in the connector positions. Each connector assembly may include coiled spring pins insertable from each side that secure the connectors in place, thus preventing disconnection or movement due to vibrations or the like. These features are beneficial in environments such as data centers, where stability and reliability reduce downtime.

The dual sets of spring pins, and their length, alignment, and the like may allow for the relatively higher number of connector pins or the like compared to the number of connector pins in other connectors. For example, in at least some scenarios, a single connector of the present disclosure may be used in place of several smaller conventional connectors. Benefits of the present disclosure may include, but are not limited to, improved configurability for accommodating various configurations such as a 13 pin or 15 pin setup. Therefore, the proposed electrical connector assembly may be particularly suited for applications in environments where space is at a premium and equipment density is high. A compact design allows for optimal use of space without compromising on the accessibility for maintenance of the electrical connections.

Additionally, the connectors may be designed to be coupled in a specific orientation, guided by a unique arrangement of mounting interfaces. This design feature prevents improper connections, thus enhancing the system's safety and functionality by ensuring that all electrical connections are correctly aligned.

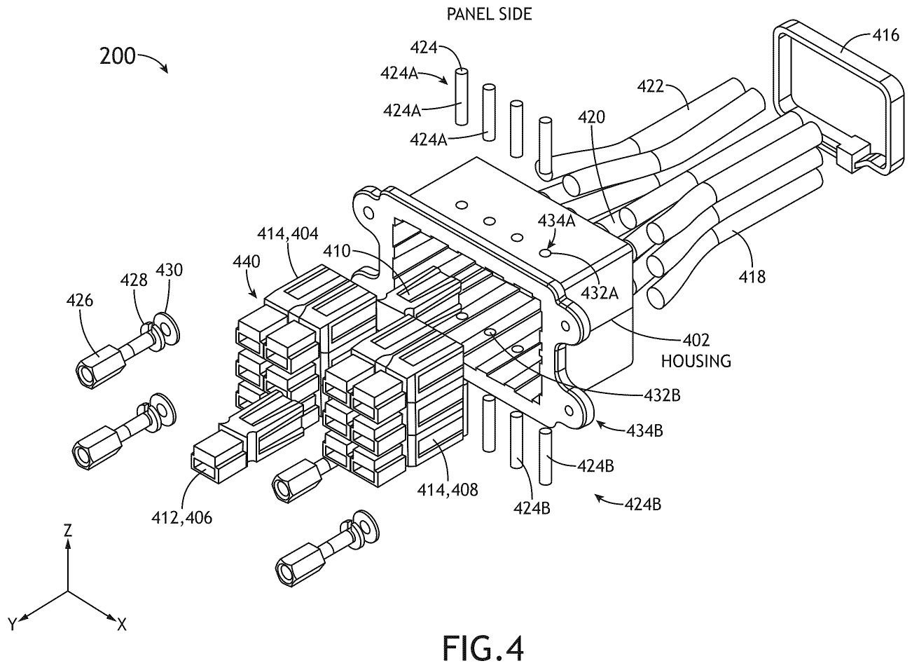

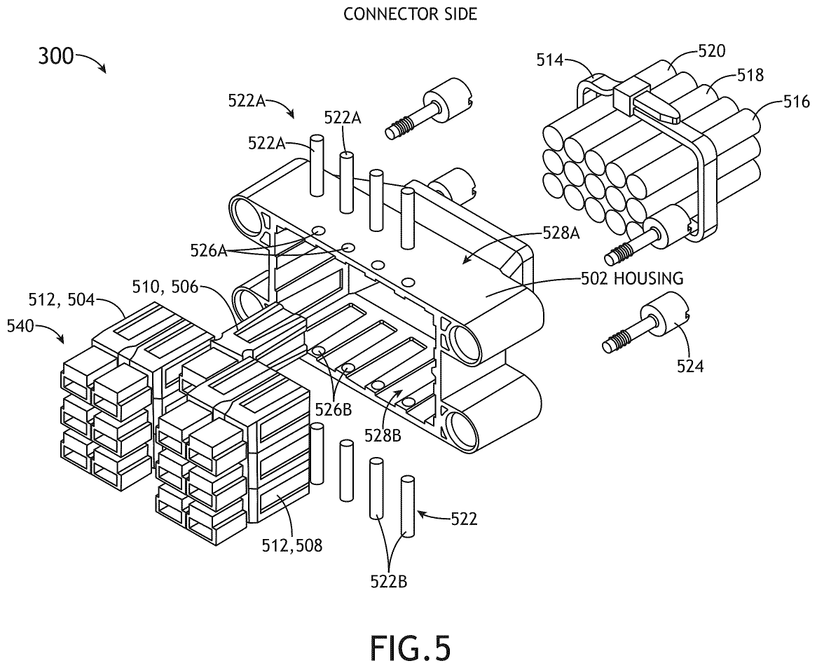

In embodiments, the connectors may be configured for an AP PP15-45 connector. For example, the connectors may be at least one of: be an AP PP15-45 connector; or be compatible with an AP PP15-45 connector. The AP PP15-45 connector may refer to a type of Powerpole connector designed by Anderson Power Products. This connector may be known for its versatility and ability to handle a wide range of current and wire sizes within a compact footprint. For example, any of connector assemblies 200, 300 and connectors of FIGS. 4 and 5 may be configured to accommodate wires ranging from #20 AWG (0.75 mm²) to 3/0 (70 mm²) and/or to support currents up to 350 A.

Certain components described herein may be conventional components, though their specific arrangement and configuration herein provide advantages. For example, wires, hermaphrodite 1P connectors, and fasteners, may exist individually in some configurations. However, it is contemplated that various embodiments herein provide a higher number of connectors in specific arrangements and configurations compared to other connectors. Further, the connectors may be retained using dual opposing sets of spring pins, and the length, alignment, and the like of such spring pins may allow for and complement the relatively higher number of connectors.

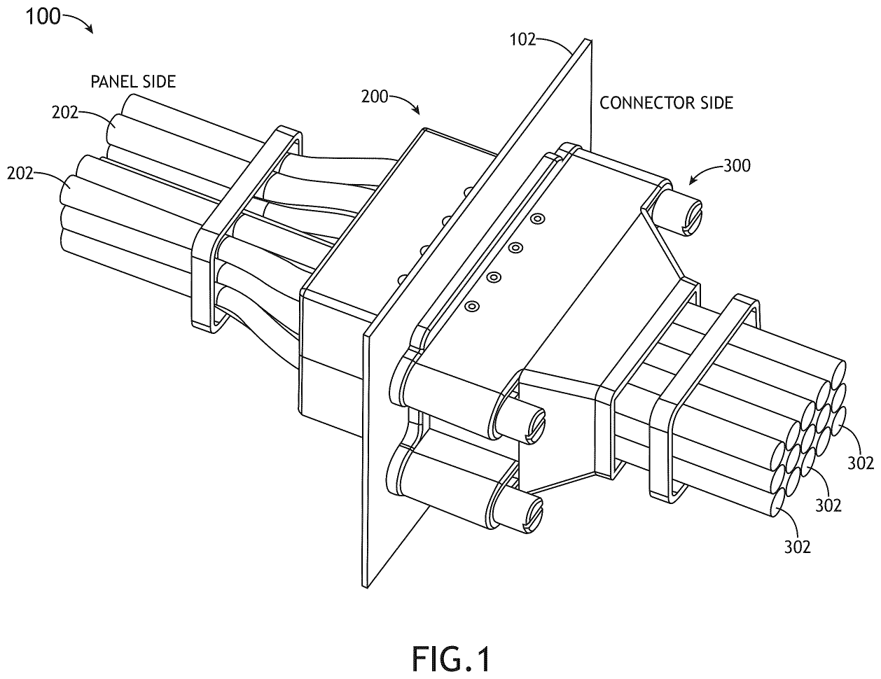

FIGS. 1-6 illustrate an example of an electrical connector assembly 100.

FIG. 1 illustrates an electrical connector assembly 100 in an assembled configuration, in accordance with one or more embodiments of the present disclosure.

The electrical connector assembly 100 may include a first connector assembly 200 and a second connector assembly 300.

The first connector assembly 200 may be a panel connector configured to mount to a panel 102. The second connector assembly 300 may be a component on the “connector side”, rather than the panel side of the assembly. The second connector assembly 300 may be configured to couple to the first connector assembly 200.

The first connector assembly 200 may be configured to receive first wires 202. For example, connectors (e.g., pins, terminals, sockets, or the like) in the first connector assembly 200 may each be coupled to a respective first wire 202. The second connector assembly 300 may be configured to receive second wires 302.

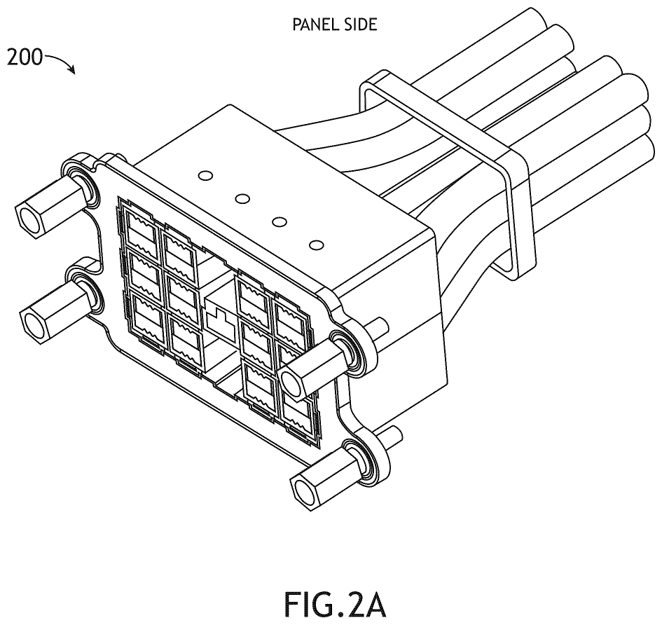

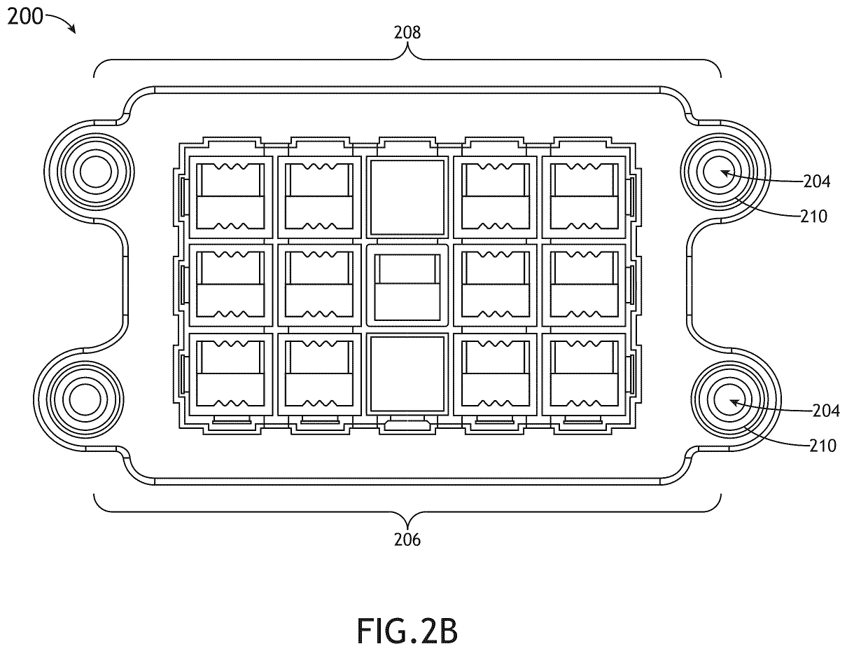

FIG. 2A illustrates a perspective view of a first connector assembly 200 of the electrical connector assembly 100, in accordance with one or more embodiments of the present disclosure. FIG. 2B illustrates a front view of the first connector assembly 200, in accordance with one or more embodiments of the present disclosure.

In embodiments, the first connector assembly 200 includes a first housing, providing structure for various elements.

The first housing may include at least four first mounting interfaces 204. For example, the first housing may include four first mounting interfaces 204 in a two-by-two arrangement. For instance, there may be a first mounting interface 204 at each corner of the first housing.

The at least four first mounting interfaces 204 may be configured to be removably couplable to at least four second mounting interfaces of the second connector assembly 300.

The four first mounting interfaces 204 may include internal threads 210 for receiving a threaded fastener. For example, referring briefly to FIG. 5, a threaded fastener 524 may be configured to be screwed into each of the first mounting interfaces 204.

The first connector assembly 200 may be configured to be removably couplable to the second connector assembly 300 in only one orientation. For example, the orientation may be when the four first mounting interfaces 204 align with corresponding mounting surfaces of the second connector assembly. This asymmetric configuration prevents improper mating of the connector assemblies by constraining coupling to a single permissible coupling orientation. This limitation of orientation for connecting may be enabled by virtue of a lateral spacing 206 between two of the mounting interfaces 204 (e.g., top two mounting interfaces 204) being different than a different lateral spacing 208 between two other mounting interfaces 204 (e.g., bottom two mounting interfaces 204).

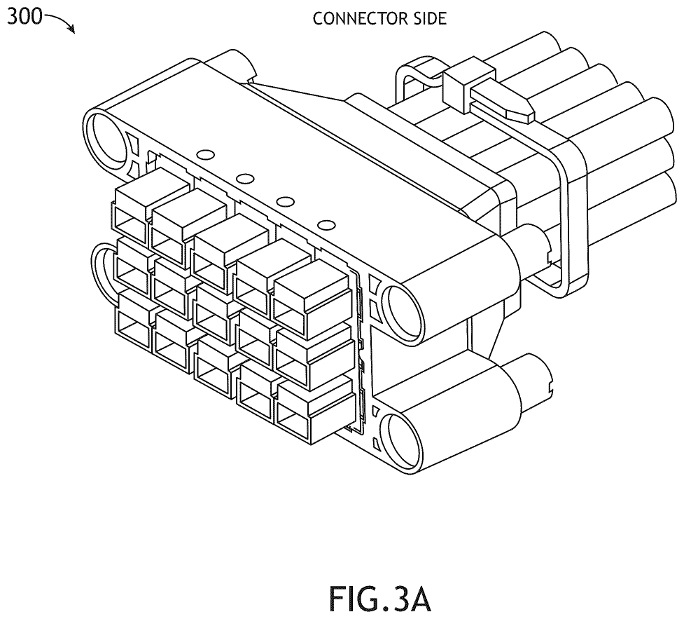

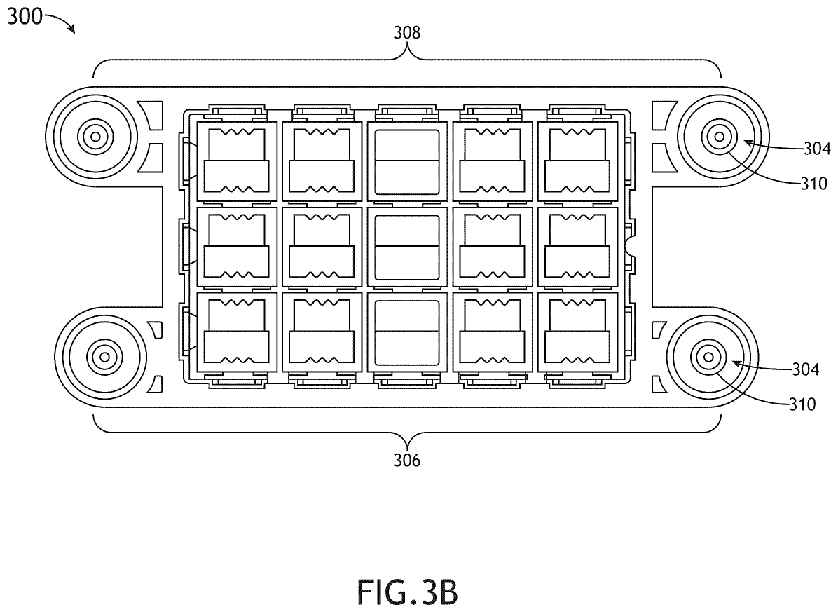

FIG. 3A illustrates a perspective view of a second connector assembly 300 of the electrical connector assembly 100, in accordance with one or more embodiments of the present disclosure. FIG. 3B illustrates a front view of the second connector assembly 300, in accordance with one or more embodiments of the present disclosure.

In embodiments, the second connector assembly 300 includes a second housing. The second housing may include at least four second mounting interfaces 304. For example, the second housing may include four second mounting interfaces 304 in a two-by-two arrangement. For instance, there may be a second mounting interface 304 at each corner of the second housing.

The at least four second mounting interfaces 304 may be configured to be removably couplable to at least four first mounting interfaces 204 of the first connector assembly 200.

The second connector assembly 300 may be configured to be removably couplable to the first connector assembly 200 in only one orientation. For example, the orientation may be when the four second mounting interfaces 304 align with corresponding mounting surfaces of the first connector assembly. This limitation of orientation for connecting may be enabled by virtue of a lateral spacing 306 between two of the mounting interfaces 304 (e.g., top two mounting interfaces 304) being different than a different lateral spacing 308 between two other mounting interfaces 304 (e.g., bottom two mounting interfaces 304).

The threaded fastener may include external threads 310. For example, the external threads 310 may be external threads of a retained fastener 524 configured to be coupled to the second housing in each corner.

FIG. 4 illustrates an exploded view of the first connector assembly 200, in accordance with one or more embodiments of the present disclosure.

The first connector assembly 200 includes a first housing 402. The first housing 402 may be configured to be removably couplable along a coupling axis to a second housing 502. See FIG. 5 for examples of components of the second connector assembly 300. The first connector assembly 200 may include a first set of hermaphrodite 1P connectors 440. The first set of hermaphrodite 1P connectors 440 may be retained by the first housing 402 and may be configured to be removably couplable to a second set of hermaphrodite 1P connectors 540 (see FIG. 5) of the second connector assembly 300.

Each connector (e.g., each hermaphrodite connector 440) of the present disclosure may be a hermaphrodite 1P connector, with a single pin (e.g., single electrical connection).

The first connector assembly 200 may include a first set of coiled spring pins 424. The first set of coiled spring pins 424 may be configured to be mounted to the first housing 402. For example, the coiled spring pins 424 may be squeezed to be a smaller diameter, inserted until an end of the coiled spring pin is flush with an outer surface of the housing, and then released to fully expand inside a respective void. In this configuration, the coiled spring pins 424 may be held in place by static friction of the spring pushing on the inside surfaces of the voids 432A, 432B. The voids 432A, 432B may be any suitable shape, such as round holes.

The first set of coiled spring pins 424 may be configured to lock the first set of hermaphrodite 1P connectors 440 into place. For example, the first set of hermaphrodite 1P connectors 440 may be fixed relative to the first housing 402, so they do not move in the coupling direction.

For example, as shown, each of the first set of coiled spring pins 424 may be configured to be inserted between two respective first hermaphrodite 1P connectors 440. The hermaphrodite 1P connectors 440 may be shaped to define voids (e.g., half of a cylindrical void on both sides) for receiving a first coiled spring pin 424 on both sides. In this way, two hermaphrodite 1P connectors 440 placed next to each other may form each half of the void for receiving a first coiled spring pin 424.

The first set of coiled spring pins 424 may be configured to be aligned lengthwise (e.g., length along cylindrical axis) along a vertical axis (Z axis) orthogonal to the coupling axis (Y axis).

Two sets of coiled spring pins 424 may be used, at half length, from each side of the first housing 402. The first set of coiled spring pins 424 may include an upper subset 424A of the first set of coiled spring pins 424. The upper subset 424A may be configured to be received by upper voids 432A defined by an upper side 434A of the first housing 402.

The first set of coiled spring pins 424 may include a lower subset 424B of the first set of coiled spring pins 424. The lower subset 424B may be configured to be received by lower voids 432B defined by a lower side 434B of the first housing 402.

In some embodiments, the first set of coiled spring pins 424 may be less than a full vertical depth along the vertical axis so that a coiled spring pin 424 may be inserted from each side. For example, in other words, a length of each of the first set of coiled spring pins 424 may be less than an entirety of a depth of the three rows as measured along the vertical axis. For instance, a length of each of the first set of coiled spring pins 424 may be at most halfway of a depth of the three rows as measured along the vertical axis.

The upper subset 424A of the first set of coiled spring pins 424 may consist of a quantity of four upper first coiled spring pins 424A. The lower subset 424B of the first set of coiled spring pins 424 may consist of a quantity of four lower first coiled spring pins 424B.

The first set of hermaphrodite 1P connectors 440 may include 15 connector positions arranged in three rows that are stacked along the vertical axis and in five columns along a lateral axis (e.g., X axis) that is orthogonal to the vertical axis (e.g., Z axis) and the coupling axis (e.g., Y axis). In some examples, at least 12 of the 15 connector positions include a hermaphrodite 1P connector 440. In some examples, as shown, at least 13 of the 15 connector positions include a hermaphrodite 1P connector 440. For example, a center column may include a blank spacer connector 410 on each side of a middle connector (e.g., an electrical ground connector). The blank spacer connectors 410 may be spacers, and not electrically functional nor coupled to a wire. In this way, 13 of the 15 connector positions may be electrically functional.

In some embodiments, each upper coiled spring pin 424A may be aligned with a respective lower coiled spring pin 424B.

The first connector assembly 200 may include a bundling element 416 for maintaining the arrangement of the first wires 418, 420, 422. For example, the bundling element 416 may be a flexible band used to bundle and secure the wires together. For instance, the bundling element 416 may be a flexible cable tie, measuring 146-200 mm in length and 3.6 mm in width, which facilitates neat storage and prevents tangling or damage to the wires.

The first connector assembly 200 may include washers 428, 430. For example, a flat washer 430 may serve to protect the surface of the first housing 402 by providing a bearing surface. For example, a spring lock washer 428 may be used to keep element 426 securely locked in place.

In some embodiments, the first connector assembly 200 may include protective casings 404, 406, 408 that enclose specific sections of the connection connectors 414, 412 to provide protection. For example, these protective casings may be color-coded—black (404), green (406), and red (408)—to signify different electrical properties or connections, such as grounding or power. For instance, these casings may facilitate quick identification and aid in maintenance.

In some embodiments, the first connector assembly 200 may include a standoff 426. The standoff 426 may be configured to maintain a fixed spacing or to provide structural support between the housing 502 and another component or surface. For example, the standoff 426 may be an M3 standoff, which refers to its compatibility with M3 size screws or bolts, used for mounting or securing the connector assembly 300 in place. The standoff 426 may include the internal threads 210 of FIG. 2B.

FIG. 5 illustrates an exploded view of the second connector assembly 300, in accordance with one or more embodiments of the present disclosure. In some embodiments, one or more (e.g., any) of the limitations of the first connector assembly 200 also apply to the second connector assembly 300. For example, parts and their limitations may be similar, identical, and/or the like. For clarity, at least some of such limitations are described in more detail below.

The second connector assembly 300 may include connection connectors 510, 512. The second connector assembly 300 may be configured to receive second wires 516, 518, 520.

In some embodiments, the second connector assembly 300 may include protective casings 504, 506, 508 that enclose specific sections of the connection connectors 510, 512 to provide protection. For example, these protective casings may be color-coded—black (504), green (506), and red (508)—to signify different electrical properties or connections.

The second connector assembly 300 may include a bundling element 514 for maintaining the arrangement of the second wires 516, 518, 520. For example, the bundling element 514 may be a flexible band used to bundle and secure the wires together. For instance, the bundling element 514 may be a flexible cable tie, measuring 146-200 mm in length and 3.6 mm in width.

Each of the first hermaphrodite 1P connectors 440 may be aligned with a respective second hermaphrodite 1P connector 540 of the second connector assembly 300.

The second connector assembly 300 may include a second housing 502. The second housing 502 may be configured to be removably couplable along a coupling axis to the first housing 402. The second connector assembly 300 may include a second set of hermaphrodite 1P connectors 540. The second set of hermaphrodite 1P connectors 540 may be retained by the second housing 502. The second connector assembly 300 may include a second set of coiled spring pins 522.

The second set of coiled spring pins 522 may be configured to be mounted to the second housing 502. For example, the coiled spring pins 522 may be compressed to be smaller, inserted until flush with an outer surface of the second housing 502 and then released, or the like. In this configuration, the coiled spring pins 522 may be held in place by static friction (and/or interference) of the spring pushing on the inside surfaces of the voids 526A, 526B. The voids 526A, 526B may be any shape, such as round holes.

The second set of coiled spring pins 522 may be configured to lock the second set of hermaphrodite 1P connectors 540 into place. For example, as shown, each of the second set of coiled spring pins 522 may be configured to be inserted between two respective second hermaphrodite 1P connectors 540. The hermaphrodite 1P connectors 540 may be shaped to define voids (e.g., half of a cylindrical void on both sides) for receiving a second coiled spring pin 522 on both sides. In this way, two hermaphrodite 1P connectors 540 placed next to each other may form each half of the void for receiving a second coiled spring pin 522.

The second set of coiled spring pins 522 may be configured to be aligned lengthwise (e.g., length along cylindrical axis) along a vertical axis (Z axis) orthogonal to the coupling axis (Y axis).

Two sets of coiled spring pins 522 may be used, at half length, from each side of the second housing 502. The second set of coiled spring pins 522 may include an upper subset 522A of the second set of coiled spring pins 522. The upper subset 522A may be configured to be received by upper voids 526A defined by an upper side 528A of the second housing 502.

The second set of coiled spring pins 522 may include a lower subset 522B of the second set of coiled spring pins 522. The lower subset 522B may be configured to be received by lower voids 526B defined by a lower side 528B of the second housing 502.

In some embodiments, the second set of coiled spring pins 522 may be less than a full vertical depth along the vertical axis so that a coiled spring pin 522 may be inserted from each side. For example, in other words, a length of each of the second set of coiled spring pins 522 may be less than an entirety of a depth of the three rows as measured along the vertical axis. For instance, a length of each of the second set of coiled spring pins 522 may be at most halfway of a depth of the three rows as measured along the vertical axis.

The upper subset 522A of the second set of coiled spring pins 522 may consist of a quantity of four upper second coiled spring pins 522A. The lower subset 522B of the second set of coiled spring pins 522 may consist of a quantity of four lower second coiled spring pins 522B.

The second set of hermaphrodite 1P connectors 540 may include 15 connector positions arranged in three rows that are stacked along the vertical axis and in five columns along a lateral axis (e.g., X axis) that is orthogonal to the vertical axis (e.g., Z axis) and the coupling axis (e.g., Y axis). In some examples, at least 12 of the 15 connector positions include hermaphrodite 1P connectors 540. In some examples, as shown, 15 of the 15 connector positions include a hermaphrodite 1P connector 540. In this way, 15 of the 15 connector positions may be electrically functional.

In some embodiments, each upper coiled spring pin 522A may be aligned with a respective lower coiled spring pin 522B.

The second connector assembly 300 may also include multiple fasteners 524. For example, the second mounting interfaces 304 of FIG. 3B may each include a fastener 524. The fastener may be a thumb screw 524 for securing the second housing 502 to the first housing 402. For example, the thumb screw 524 may be used to easily tighten or loosen the connection without requiring additional tools.

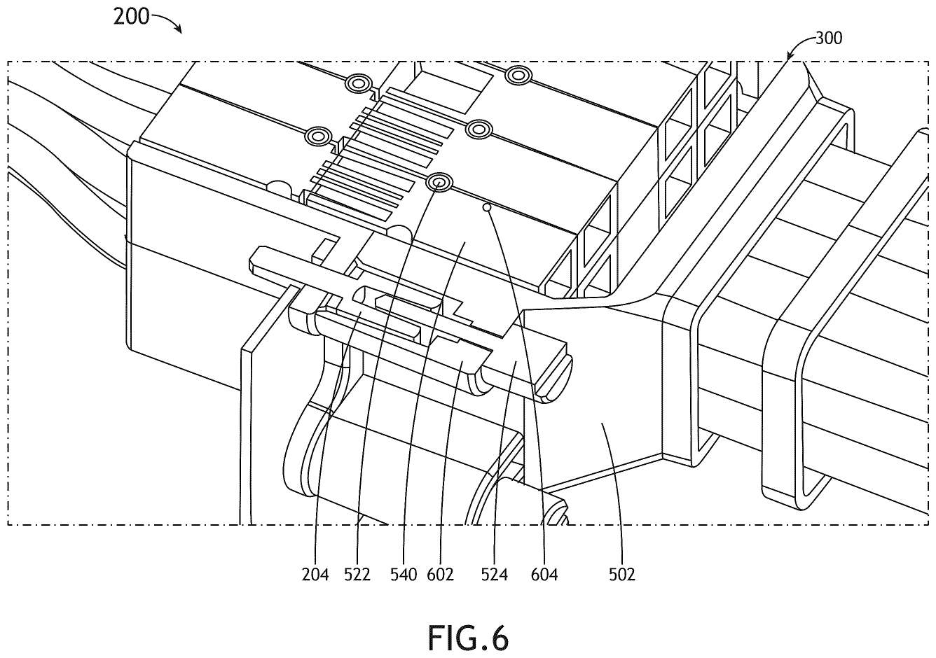

FIG. 6 illustrates a cross-sectional view of the electrical connector assembly 100, in accordance with one or more embodiments of the present disclosure.

As shown, fastener 524 may be configured to pass through a portion 602 of the second housing and thread into the first mounting interface 204 to secure the second connector assembly 300 in place.

Area 604 illustrates a cross-sectional view of a coiled spring pin 522 locking a hermaphrodite 1P connector 540 in place.

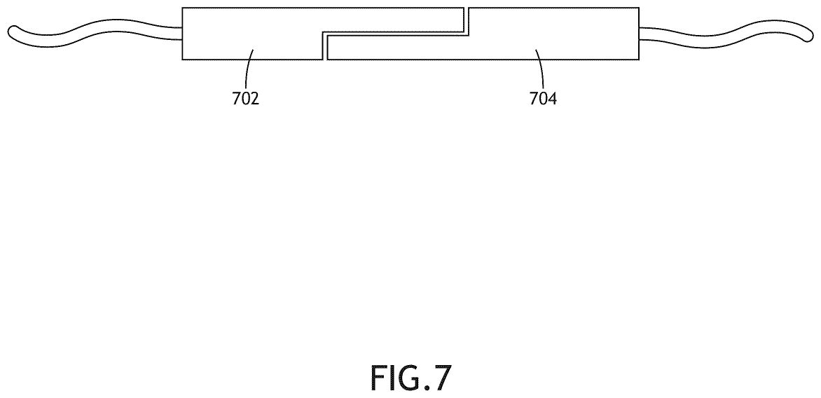

FIG. 7 illustrates a simplified diagram of a hermaphrodite 1P connector 702 coupled to another hermaphrodite 1P connector 704 of the same design when rotated 180 degrees, in accordance with one or more embodiments of the present disclosure.

In this way, the same part may be used, but is not necessarily required to be used, for the first connector assembly 200 and the second connector assembly 300.

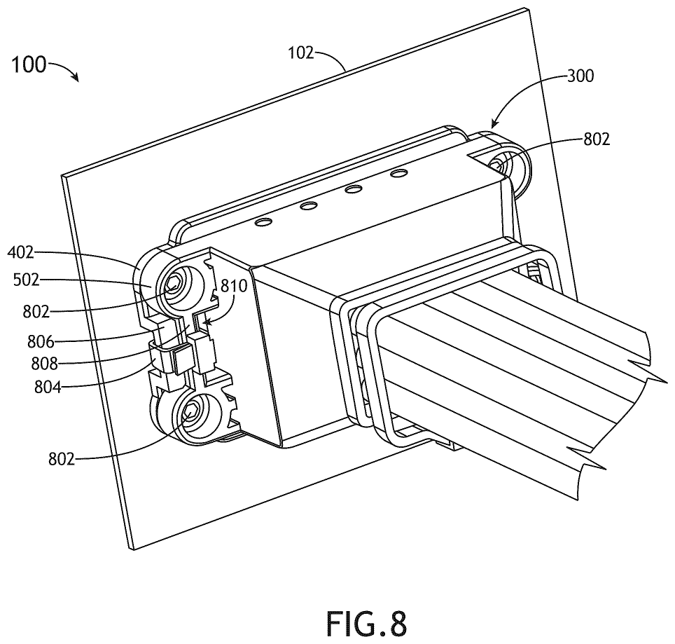

FIG. 8 illustrates an electrical connector assembly 100 in an assembled configuration and including an alternate coupling mechanism, in accordance with one or more embodiments of the present disclosure. In some embodiments, rather than thumb screws 524, other ways of fastening may be used, such as cable ties (e.g., zip ties) and/or simpler fasteners (e.g., M3 torx screw (ISO 14583) or the like). For example, FIG. 8 may illustrate a potentially more economical way of coupling the second housing 502 to the first housing 402.

In some embodiments, the electrical connector assembly 100 includes fasteners 802 configured to be received by the second mounting interfaces 304 of FIG. 3B. For example, the fasteners 802 may be any fastener, such as at least one of a bolt or a screw. For instance, the fasteners 802 may be a M3 torx screw. The fasteners 802 may be configured to be received by the panel via holes in the panel. The fasteners 802 may be configured to be received by the first mounting interfaces 204 such as internal threads 210 in the first mounting interfaces 204 as shown in FIG. 2B.

In some embodiments, alternatively and/or in addition, the electrical connector assembly 100 includes a coupling element 804 on each side of the electrical connector assembly 100. The coupling element 804 may be configured to be received by a void 810 (e.g., gap, hole, etc.). For example, the void 810 may be defined by the first housing 402 and the second housing 502 such that the coupling element 804 (e.g., cable tie) may be pushed along the panel 102 and in and out through the first housing 402 and the second housing 502. Gapped portions 806, 808 may be adjacent to the void 810, and gapped away from the panel 102. The coupling element 804 may be configured to wrap around a first gapped portion 806 of the first housing 402 and a second gapped portion 808 of the second housing 502. In this way, the coupling elements 804 may aid in securing the second housing 502 to the first housing 402.

Embodiments may be configured for any power system. For example, the electrical connector assembly 100 may be configured as an uninterruptible power supply connector. For example, the electrical connector assembly 100 may be configured as a DC power system connector. For example, the electrical connector assembly 100 may be configured as a power distribution unit connector.

Embodiments may be configured for ease of manufacturing. For example, the first housing 402 and second housing 502 may be configured to be fabricated using injection molding sliders. For instance, the first housing 402 and second housing 502 may lack enclosed internal cavities or the like that cannot be manufactured using injection molding sliders. By way of another example, the first housing 402 and second housing 502 may be configured to be fabricated using additive manufacturing. For instance, the first housing 402 and second housing 502 may be configured to be fabricated using Fused Deposition Modeling (FDM). For instance, the first housing 402 and second housing 502 may be configured to be fabricated using Selective Laser Sintering (SLS).

In embodiments, a method of producing the first housing 402 and second housing 502 may include any of the above, such as injection molding sliders, additive manufacturing (e.g., FDM, SLS), and/or the like. The method may include assembly of the electrical connector assembly 100, including any component described in the present disclosure.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

We claim:

1. An electrical connector assembly comprising:
a first connector assembly, the first connector assembly comprising:
a first housing configured to be removably couplable along a coupling axis to a second housing of a second connector assembly;
a first set of hermaphrodite 1P connectors retained by the first housing and configured to be removably couplable to a second set of hermaphrodite 1P connectors of the second connector assembly; and
a first set of coiled spring pins configured to be mounted to the first housing, to lock in place the first set of hermaphrodite 1P connectors relative to the first housing, and aligned lengthwise along a vertical axis orthogonal to the coupling axis,
wherein the first set of coiled spring pins comprises:
an upper subset of the first set of coiled spring pins configured to be received by upper voids defined by an upper side of the first housing; and
a lower subset of the first set of coiled spring pins configured to be received by lower voids defined by a lower side of the first housing.

2. The electrical connector assembly of claim 1, wherein the first connector assembly comprises 15 connector positions arranged in three rows that are stacked along the vertical axis and in five columns along a lateral axis that is orthogonal to the vertical axis and the coupling axis, and wherein at least 13 of the 15 connector positions comprise hermaphrodite 1P connectors.

3. The electrical connector assembly of claim 2, wherein a length of each of the first set of coiled spring pins is less than an entirety of a depth of the three rows as measured along the vertical axis.

4. The electrical connector assembly of claim 2, wherein a length of each of the first set of coiled spring pins is at most halfway of a depth of the three rows as measured along the vertical axis.

5. The electrical connector assembly of claim 1, wherein the first housing further comprises at least four first mounting interfaces configured to be removably couplable to at least four second mounting interfaces of the second connector assembly,
and wherein the first connector assembly is configured to be removably couplable to the second connector assembly in only one orientation by virtue of a lateral spacing between two mounting interfaces of the at least four first mounting interfaces being different than a different lateral spacing between two other mounting interfaces of the at least four first mounting interfaces.

6. The electrical connector assembly of claim 5, wherein the at least four first mounting interfaces include internal threads for receiving a threaded fastener.

7. The electrical connector assembly of claim 1, wherein the upper subset of the first set of coiled spring pins consists of a quantity of four upper first set of coiled spring pins and wherein the lower subset of the first set of coiled spring pins consists of a quantity of four lower first set of coiled spring pins.

8. An electrical connector assembly comprising:
a second connector assembly, the second connector assembly comprising:
a second housing configured to be removably couplable along a coupling axis to a first housing of a first connector assembly;
a second set of hermaphrodite 1P connectors retained by the second housing and configured to be removably couplable to a first set of hermaphrodite 1P connectors of the first connector assembly; and
a second set of coiled spring pins configured to be mounted to the second housing, to lock in place the second set of hermaphrodite 1P connectors relative to the second housing, and aligned lengthwise along a vertical axis orthogonal to the coupling axis,
wherein the second set of coiled spring pins comprises:
an upper subset of the second set of coiled spring pins configured to be received by upper voids defined by an upper side of the second housing; and
a lower subset of the second set of coiled spring pins configured to be received by lower voids defined by a lower side of the second housing.

9. The electrical connector assembly of claim 8, wherein the second connector assembly comprises 15 hermaphrodite 1P connectors arranged in three rows that are stacked along the vertical axis and in five columns along a lateral axis that is orthogonal to the vertical axis and the coupling axis.

10. The electrical connector assembly of claim 9, wherein a length of each of the second set of coiled spring pins is less than an entirety of a depth of the three rows as measured along the vertical axis.

11. The electrical connector assembly of claim 9, wherein a length of each of the second set of coiled spring pins is at most halfway of a depth of the three rows as measured along the vertical axis.

12. The electrical connector assembly of claim 8, wherein the second housing further comprises at least four second mounting interfaces configured to be removably couplable to at least four first mounting interfaces of the first connector assembly, and wherein the second connector assembly is configured to be removably couplable to the first connector assembly in only one orientation by virtue of a lateral spacing between two mounting interfaces of the at least four second mounting interfaces being different than a different lateral spacing between two other mounting interfaces of the at least four second mounting interfaces.

13. The electrical connector assembly of claim 12, wherein each second mounting interface of the at least four second mounting interfaces includes a threaded fastener configured to couple to a first mounting interface of the first connector assembly.

14. The electrical connector assembly of claim 8, wherein the upper subset of the second set of coiled spring pins consists of a quantity of four upper second set of coiled spring pins and wherein the lower subset of the second set of coiled spring pins consists of a quantity of four lower second set of coiled spring pins.

15. The electrical connector assembly of claim 8, wherein the second housing comprises a second gapped portion adjacent to a void defined by the second housing, wherein the void is configured to receive a cable tie for securing the second housing to the first housing.

16. An electrical connector assembly comprising:
a first connector assembly, the first connector assembly comprising:
a first housing configured to be removably couplable along a coupling axis to a second housing of a second connector assembly;
a first set of hermaphrodite 1P connectors retained by the first housing and configured to be removably couplable to a second set of hermaphrodite 1P connectors of the second connector assembly; and
a first set of coiled spring pins configured to be mounted to the first housing, to lock in place the first set of hermaphrodite 1P connectors relative to the first housing, and aligned lengthwise along a vertical axis orthogonal to the coupling axis,
wherein the first set of coiled spring pins comprises:
an upper subset of the first set of coiled spring pins configured to be received by upper voids defined by an upper side of the first housing; and
a lower subset of the first set of coiled spring pins configured to be received by lower voids defined by a lower side of the first housing; and
the second connector assembly, the second connector assembly comprising:
the second housing configured to be removably couplable along the coupling axis to the first housing of the first connector assembly;
the second set of hermaphrodite 1P connectors retained by the second housing and configured to be removably couplable to the first set of hermaphrodite 1P connectors of the first connector assembly; and
a second set of coiled spring pins configured to be mounted to the second housing, to lock in place the second set of hermaphrodite 1P connectors relative to the second housing, and aligned lengthwise along the vertical axis orthogonal to the coupling axis,
wherein the second set of coiled spring pins comprises:
an upper subset of the second set of coiled spring pins configured to be received by upper voids defined by an upper side of the second housing; and
a lower subset of the second set of coiled spring pins configured to be received by lower voids defined by a lower side of the second housing.

17. The electrical connector assembly of claim 16, wherein the first connector assembly comprises 15 connector positions arranged in three rows that are stacked along the vertical axis and in five columns along a lateral axis that is orthogonal to the vertical axis and the coupling axis, and wherein at least 13 of the 15 connector positions comprise hermaphrodite 1P connectors.

18. The electrical connector assembly of claim 17, wherein a length of each of the first set of coiled spring pins is less than an entirety of a depth of the three rows as measured along the vertical axis.

19. The electrical connector assembly of claim 17, wherein a length of each of the first set of coiled spring pins is at most halfway of a depth of the three rows as measured along the vertical axis.

20. The electrical connector assembly of claim 16, wherein the first housing further comprises at least four first mounting interfaces configured to be removably couplable to at least four second mounting interfaces of the second connector assembly,
and wherein the first connector assembly is configured to be removably couplable to the second connector assembly in only one orientation by virtue of a lateral spacing between two mounting interfaces of the at least four first mounting interfaces being different than a different lateral spacing between two other mounting interfaces of the at least four first mounting interfaces.
